(19) United States
(12) Patent Application Publication
(10) Pub. No.: US 2016/0019328 A1
(43) Pub. Date: Jan. 21, 2016

(54) UPDATING RELIABILITY PREDICTIONS USING MANUFACTURING ASSESSMENT DATA

(71) Applicant: International Business Machines Corporation, Armonk, NY (US)

(72) Inventors: Jeanne P. Bickford, Essex Junction, VT (US); Nazmul Habib, South Burlington, VT (US); Baozhen Li, South Burlington, VT (US)

(21) Appl. No.: 14/335,402

(22) Filed: Jul. 18, 2014

(51) Int. Cl. G06F 17/50

(52) U.S. Cl. CPC G06F 17/5036

(57) ABSTRACT

In an approach to predicting reliability of semiconductor devices, one or more computer processors retrieve a first reliability prediction associated with a first reliability model. The one or more computer processors retrieve manufacturing reliability assessment data for a first manufacturing vintage of semiconductor devices. The one or more computer processors retrieve failure mechanism identification data associated with the manufacturing reliability assessment data. The one or more computer processors determine, based, at least in part, on the manufacturing reliability assessment data and associated failure mechanism identification data, a second reliability prediction. The one or more computer processors determine whether the second reliability prediction matches the first reliability prediction. Responsive to determining the second reliability prediction does not match the first reliability prediction, the one or more computer processors update the first reliability model.

### BACKGROUND OF THE INVENTION

The present invention relates generally to the field of semiconductor devices, and more particularly to predicting the reliability of semiconductor devices and systems.

Integrated circuits on semiconductor devices are found in a wide variety of equipment, including household appliances, consumer electronics, communications systems, automotive systems, aircraft, and the like. As dependence on integrated circuits has increased, the reliability of these devices has increasingly become an important concern. In general, as devices scale to smaller dimensions and more advanced silicon fabrication technologies, they often become less reliable for the same use conditions. Reliability is a design engineering discipline that applies scientific knowledge to assure a product will perform its intended function for the required duration within a given environment. This includes designing in the ability to maintain, test, and support the product throughout its total life cycle.

Integrated circuits on semiconductor devices, or chips, have failure mechanisms dependent on product use conditions or the various stresses applied to the devices that are unique to semiconductors, and resolving these problems during the process development stage is an important element for providing high reliability of the semiconductor devices. For example, typical failure mechanisms that can pose problems for semiconductor devices may include time-dependent dielectric breakdown (TDDB), hot carrier injection (HCI), biased temperature instability (BTI), soft error rate (SER), retention disturbance, electromigration (EM), stress migration (SM), and TDDB between metal lines. Reliability device simulators are capable of modeling these failure mechanisms and have become an integral part of the design process of semiconductor devices. For example, the failure mechanisms may be modeled using the simulators during the semiconductor device design process in order to set failure rates such that the semiconductor device may operate reliably for a minimum expected useful life.

### SUMMARY

According to one embodiment of the present invention, a method for predicting reliability of semiconductor devices is provided. The method may include one or more computer processors retrieving a first reliability prediction associated with a first reliability model. The one or more computer processors retrieve manufacturing reliability assessment data for a first manufacturing vintage of semiconductor devices. The one or more computer processors retrieve failure mechanism identification data associated with the manufacturing reliability assessment data. The one or more computer processors determine, based, at least in part, on the manufacturing reliability assessment data and associated failure mechanism identification data, a second reliability prediction. The one or more computer processors determine whether the second reliability prediction matches the first reliability prediction. In an embodiment of the present invention, responsive to determining the second reliability prediction does not match the first reliability prediction, the one or more computer processors update the first reliability model.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 is a flowchart depicting operational steps of a reliability program, on a client computing device within the distributed data processing environment of FIG. 1, for updating reliability predictions using manufacturing reliability assessment data, in accordance with an embodiment of the present invention; and

FIG. 3 depicts a block diagram of components of the client computing device of FIG. 1, in accordance with an embodiment of the present invention.

### DETAILED DESCRIPTION

Conventionally, reliability failure mechanisms are evaluated as a semiconductor device technology is developed, and one failure rate may be set for the entire manufacturing process distribution for each of the failure mechanisms. Thereafter, all of the failure rates set for the individual failure mechanisms are combined together to set one failure rate for the semiconductor device. Even if reliability models take into account failure mechanisms attributed to specific process window bins, in general, the models are developed once and are not updated to reflect improvement in the manufacturing process as the process matures or degradation in the manufacturing process due to a process event.

Embodiments of the present invention recognize that improvements in reliability prediction can be made by utilizing failure mechanism data generated by manufacturing reliability screens and monitors to update the prediction model. Implementation of embodiments of the invention may take a variety of forms, and exemplary implementation details are discussed subsequently with reference to the Figures.

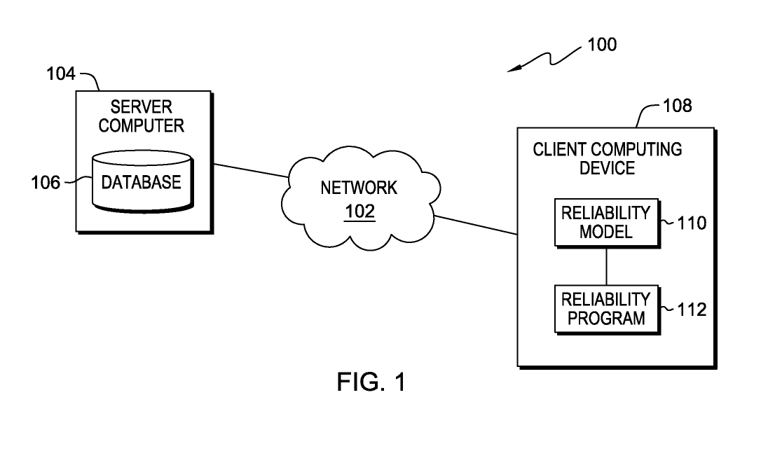

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 108, interconnected over network 102. Network 102 can be, for example, a telecommunications network, a local area network (LAN), a wide area network (WAN), such as the Internet, or a combination of the three, and can include wired, wireless, or fiber optic connections. Network 102 may include one or more wired and/or wireless networks that are capable of receiving and transmitting data, voice, and/or video signals, including multimedia signals that include voice, data, and video information.

Server computer 104 may be a management server, a web server, or any other electronic device or computing system capable of receiving and sending data. In other embodiments, server computer 104 may represent a server computing system utilizing multiple computers as a server system, such as in a cloud computing environment. In another embodiment, server computer 104 may be a laptop computer, a tablet computer, a netbook computer, a personal computer (PC), a desktop computer, a personal digital assistant (PDA), a smart phone, or any programmable electronic device capable of communicating with client computing device 108 via network 102. In another embodiment, server computer 104 represents a computing system utilizing clustered computers and components to act as a single pool of seamless resources. Server computer 104 includes database 106.

Database 106 resides on server computer 104. In another embodiment, database 106 may reside on client computing device 108, or elsewhere in the environment. A database is an organized collection of data. Database 106 can be implemented with any type of storage device capable of storing data that may be accessed and utilized by server computer 104, such as a database server, a hard disk drive, or a flash memory. In other embodiments, database 106 can represent multiple storage devices within server computer 104. Database 106 stores manufacturing reliability assessment data that results from manufacturing monitors and screen tests. Database 106 may also store failure analysis data and results, including failure mechanism identification, from samples of semiconductor devices that failed the manufacturing monitors or screen tests.

Client computing device 108 may be a desktop computer, a laptop computer, a tablet computer, a specialized computer server, a smart phone, or any programmable electronic device capable of communicating with server computer 104 via network 102 and with various components and devices within video data processing environment 100. In general, client computing device 108 represents any programmable electronic device or combination of programmable electronic devices capable of executing machine readable program instructions and communicating with other computing devices via a network, such as network 102. Client computing device 108 includes reliability model 110 and reliability program 112.

Reliability model 110 is a collection of algorithms and equations used to predict reliability of semiconductor devices. In an exemplary embodiment, reliability model 110 is a model that generates aggregate or integrated reliability predictions as a function of the process window distribution. In the exemplary embodiment, reliability model 110 uses input data that may include product data, manufacturing data, and physics of failure models. The product data and manufacturing data may include device layout schemes, layer thicknesses, layer materials, voltages, etc. The physics of failure models leverage the knowledge and understanding of the processes and failure mechanisms (e.g., TDDB, HCI, BTI, EM, etc.) that induce failure in semiconductor devices to predict reliability and improve the semiconductor device performance. Reliability model 110 may include degradation algorithms that describe how physical, chemical, mechanical, thermal, or electrical mechanisms evolve over time and eventually induce failure within the semiconductor devices. Reliability model 110 resides on client computing device 108. In another embodiment, reliability model 110 may reside on server computer 104 or elsewhere in distributed data processing environment 100, provided reliability program 112 can communicate with reliability model 110 via network 102.

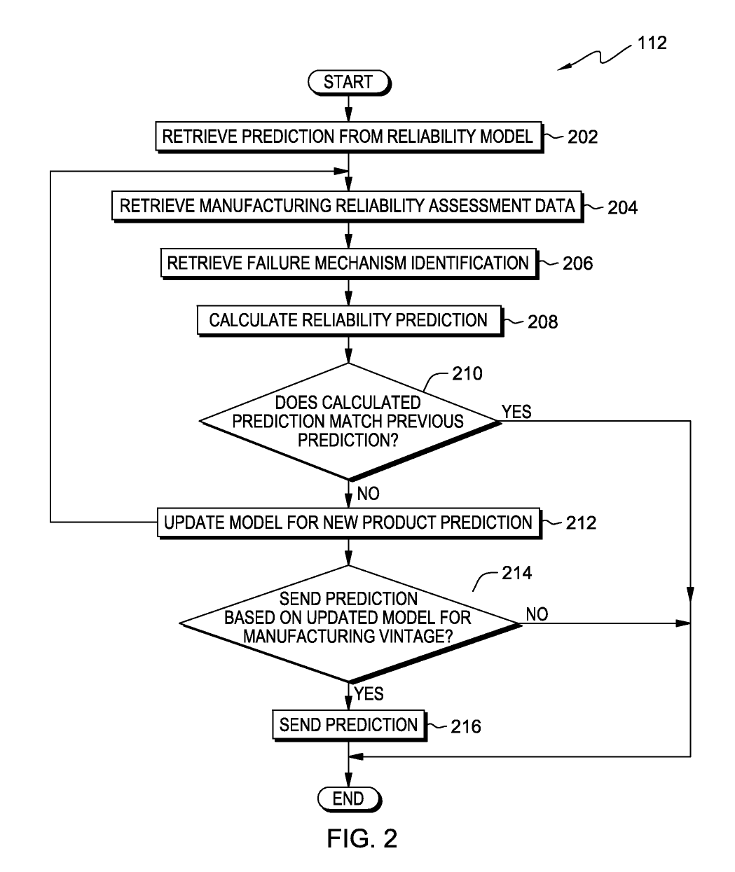

Reliability program 112 uses manufacturing reliability assessment data stored in database 106 to determine whether reliability model 110 is accurate or whether reliability model 110 can be updated to improve the reliability prediction. Manufacturing reliability assessment data may include test results as well as identification of failure mechanisms revealed by a failure analysis of semiconductor devices that failed testing. Reliability program 112 may also send an updated reliability prediction for the manufacturing vintage of the semiconductor devices for which reliability program 112 retrieved manufacturing reliability assessment data. Reliability program 112 is depicted and described in further detail with respect to FIG. 2.

FIG. 2 is a flowchart depicting operational steps of reliability program 112, on client computing device 108 within distributed data processing environment 100 of FIG. 1, for updating reliability predictions using manufacturing reliability assessment data, in accordance with an embodiment of the present invention.

Reliability program 112 retrieves a reliability prediction from a reliability model (step 202). During the process development or qualification stage of a new semiconductor device or technology, a reliability prediction model, such as reliability model 110, creates a reliability prediction for the new semiconductor device or technology. In an exemplary embodiment, reliability model 110 is designed as a function of failure mechanisms of the semiconductor device. For example, performance process window bins are defined, and a percentage of the manufacturing distribution is assigned to each performance process window bin. A bin may be a range of speeds at which the semiconductor devices operate. Reliability model 110 is an aggregate model that uses the manufacturing distributions. For failure mechanisms that are a function of the process window, reliability model 110 utilizes a mechanism-specific reliability model for each bin. For failure mechanisms that are not a function of the process window, reliability model 110 utilizes a model that is the same failure level for each bin. Reliability model 110 calculates a reliability prediction based on previously collected data. For example, after qualification testing for a new semiconductor device design is complete, and failure mechanism data is generated, reliability model 110 uses the qualification and failure mechanism data to calculate a reliability prediction for the new design. Reliability program 112 retrieves the reliability prediction calculated by reliability model 110.

Reliability program 112 retrieves manufacturing reliability assessment data (step 204). As part of the semiconductor device manufacturing process, manufacturing reliability screens, or monitors, are performed on a subset of devices from a particular manufacturing vintage. Manufacturing reliability screens include, but are not limited to, voltage screens and burn-in. These tests can be performed on all or a sample of a product. Data from testing of a product of a particular technology can be used to predict reliability for other products manufactured using the same technology. Test results from the screens are stored in database 106. Upon completion of a manufacturing reliability screen test, reliability program 112 retrieves the stored test results from database 106 for use in predicting reliability of the manufacturing vintage represented by the subset of devices.

Reliability program 112 retrieves failure mechanism identification (step 206). Upon completion of a manufacturing reliability screen test, if any semiconductor devices have failed the test, a sample of identified test failures are analyzed to determine the failure mechanism responsible for causing the device to fail the test. Failure mechanism identification data is stored in database 106. Reliability program 112 retrieves the failure mechanism identification data from database 106.

Reliability program 112 calculates a reliability prediction (step 208). Reliability program 112 feeds the retrieved manufacturing reliability assessment data and the associated failure mechanism data into reliability model 110 to calculate a reliability prediction based on the retrieved data. For example, the manufacturing reliability screen data may include a significant number of failures for which the failure mechanism is identified as time-dependent dielectric breakdown (TDDB) which was previously included as only a minor factor in reliability model 110.

Reliability program 112 determines whether the calculated reliability prediction matches the previous prediction (decision block 210). In various embodiments, a user of reliability program 112 determines a pre-defined threshold value with which a comparison of the calculated reliability prediction to the previous reliability prediction must be within to consider the predictions matching. Reliability program 112 compares the reliability prediction calculated using the manufacturing reliability assessment data and the associated failure mechanism data to the previous reliability prediction made by reliability model 110 to determine whether the difference between the two predictions is within the pre-defined threshold value. If reliability program 112 determines that the calculated prediction matches the previous prediction (“yes” branch, decision block 210), then reliability program 112 ends. If the calculated prediction matches the previous prediction, then incorporating the manufacturing reliability screen data and the associated failure mechanism data in reliability model 110 does not produce a different reliability prediction.

If reliability program 112 determines that the calculated prediction does not match the previous prediction (“no” branch, decision block 210), then reliability program 112 updates reliability model 110 for new product reliability predictions (step 212). In the previous example, the manufacturing screen data indicated that the value assigned to the failure mechanism TDDB is not correct. Reliability program 112 updates reliability model 110 to use the updated value for the TDDB failure mechanism. Reliability predictions for product already in production and for future new product introductions using reliability model 110 may be more accurate due to the updated model. Upon updating reliability model 110, reliability program 112 returns to step 204 to retrieve any available new manufacturing reliability screen data, and iteratively continue the process of improving the accuracy of reliability model 110.

Reliability program 112 determines whether to send the prediction based on the updated model for the manufacturing vintage that yielded the data on which the calculated prediction is based (decision block 214). If the calculated reliability prediction, based on the updated model, is not the same as the previous reliability prediction, then there may be a need to send the calculated prediction to a user for consideration in dispositioning the manufacturing vintage. For example, if a manufacturing process event occurred that significantly degraded the predicted reliability for the recently screened semiconductor devices, a user may want to receive the data for review. In one embodiment, reliability program 112 determines whether or not to send the calculated prediction by determining whether or not the calculated prediction matches a target reliability prediction for the manufacturing vintage, and may require a user's attention. In another embodiment, reliability program 112 may notify a user that data is available and query the user as to whether the user wants to receive the calculated reliability prediction.

If reliability program 112 determines to send the calculated reliability prediction (“yes” branch, decision block 214), then reliability program 112 sends the prediction (step 216). If reliability program 112 determines not to send the calculated reliability prediction (“no” branch, decision block 214), or responsive to sending the calculated prediction (step 216), then reliability program 112 ends.

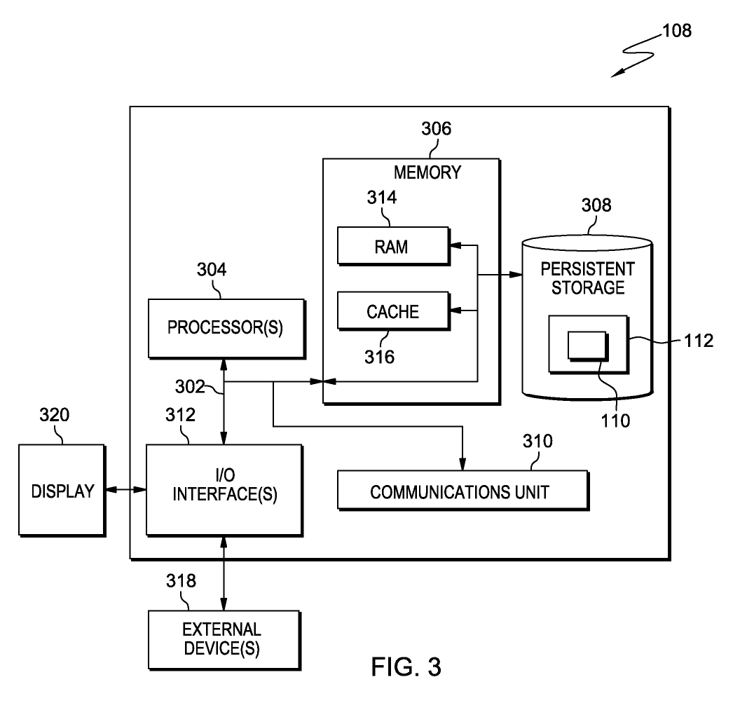

FIG. 3 depicts a block diagram of components of client computing device 108, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Client computing device 108 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media.

Reliability model 110 and reliability program 112 are stored in persistent storage 308 for execution and/or access by one or more of the respective computer processor(s) 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of server computer 104. In these examples, communications unit 310 includes one or more network interface cards. Communications unit 310 may provide communications through the use of either or both physical and wireless communications links. Reliability model 110 and reliability program 112 may be downloaded to persistent storage 308 through communications unit 310.

I/O interface(s) 312 allows for input and output of data with other devices that may be connected to client computing device 108. For example, I/O interface(s) 312 may provide a connection to external device(s) 318 such as a keyboard, a keypad, a touch screen, a microphone, and/or some other suitable input device. External device(s) 318 can also include portable computer readable storage media such as, for example, thumb drives, portable optical or magnetic disks, and memory cards. Software and data used to practice embodiments of the present invention, e.g., reliability model 110 and reliability program 112, can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for predicting reliability of semiconductor devices, the method comprising:
retrieving, by one or more computer processors, a first reliability prediction associated with a first reliability model;
retrieving, by the one or more computer processors, manufacturing reliability assessment data for a first manufacturing vintage of semiconductor devices;
retrieving, by the one or more computer processors, failure mechanism identification data associated with the manufacturing reliability assessment data;
determining, by the one or more computer processors, based, at least in part, on the manufacturing reliability assessment data and associated failure mechanism identification data, a second reliability prediction; and
determining, by the one or more computer processors, whether the second reliability prediction matches the first reliability prediction.

2. The method of claim 1, further comprising:
responsive to determining the second reliability prediction does not match the first reliability prediction, determining, by the one or more computer processors, whether the second reliability prediction matches a target reliability of the first manufacturing vintage of semiconductor devices; and
responsive to determining the second reliability prediction does not match the target reliability of the first manufacturing vintage of semiconductor devices, sending, by the one or more computer processors, the second reliability prediction to a user associated with the first manufacturing vintage of semiconductor devices.

3. The method of claim 1, wherein determining whether the second reliability prediction matches the first reliability prediction further comprises determining, by the one or more computer processors, whether a difference between the second reliability prediction and the first reliability prediction is within a pre-defined threshold value.

4. The method of claim 1, wherein manufacturing reliability assessment data includes results from one or more manufacturing reliability screen tests, wherein the one or more manufacturing reliability screen tests include at least one of voltage screens and burn-in.

5. The method of claim 1, further comprising, responsive to determining the second reliability prediction does not match the first reliability prediction, updating, by the one or more computer processors, the first reliability model.

6. The method of claim 5, wherein updating the first reliability model further comprises including the retrieved manufacturing reliability assessment data and associated failure mechanism identification data in the first reliability model to create a second reliability model.

7. The method of claim 1, further comprising, responsive to determining the second reliability prediction does match the first reliability prediction, maintaining, by the one or more computer processors, the first reliability model.

8. A computer program product for predicting reliability of semiconductor devices, the computer program product comprising:
one or more computer readable storage media and program instructions stored on the one or more computer readable storage media, the program instructions comprising:
program instructions to retrieve a first reliability prediction associated with a first reliability model;
program instructions to retrieve manufacturing reliability assessment data for a first manufacturing vintage of semiconductor devices;
program instructions to retrieve failure mechanism identification data associated with the manufacturing reliability assessment data;
program instructions to determine, based, at least in part, on the manufacturing reliability assessment data and associated failure mechanism identification data, a second reliability prediction; and
program instructions to determine whether the second reliability prediction matches the first reliability prediction.

9. The computer program product of claim 8, further comprising:
responsive to determining the second reliability prediction does not match the first reliability prediction, program instructions to determine whether the second reliability prediction matches a target reliability of the first manufacturing vintage of semiconductor devices; and
responsive to determining the second reliability prediction does not match the target reliability of the first manufacturing vintage of semiconductor devices, program instructions to send the second reliability prediction to a user associated with the first manufacturing vintage of semiconductor devices.

10. The computer program product of claim 8, wherein program instructions to determine whether the second reliability prediction matches the first reliability prediction further comprises program instructions to determine whether a difference between the second reliability prediction and the first reliability prediction is within a pre-defined threshold value.

11. The computer program product of claim 8, wherein manufacturing reliability assessment data includes results from one or more manufacturing reliability screen tests, wherein the one or more manufacturing reliability screen tests include at least one of voltage screens and burn-in.

12. The computer program product of claim 8, further comprising, responsive to determining the second reliability prediction does not match the first reliability prediction, program instructions to update the first reliability model.

13. The computer program product of claim 12, wherein updating the first reliability model further comprises including the retrieved manufacturing reliability assessment data and associated failure mechanism identification data in the first reliability model to create a second reliability model.

14. The computer program product of claim 8, further comprising, responsive to determining the second reliability prediction does match the first reliability prediction, program instructions to maintain the first reliability model.

15. A computer system for predicting reliability of semiconductor devices, the computer system comprising:
one or more computer processors;
one or more computer readable storage media;
program instructions stored on the computer readable storage media for execution by at least one of the one or more processors, the program instructions comprising:
program instructions to retrieve a first reliability prediction associated with a first reliability model;
program instructions to retrieve manufacturing reliability assessment data for a first manufacturing vintage of semiconductor devices;
program instructions to retrieve failure mechanism identification data associated with the manufacturing reliability assessment data;
program instructions to determine, based, at least in part, on the manufacturing reliability assessment data and associated failure mechanism identification data, a second reliability prediction; and
program instructions to determine whether the second reliability prediction matches the first reliability prediction.

16. The computer system of claim 15, further comprising:
responsive to determining the second reliability prediction does not match the first reliability prediction, program instructions to determine whether the second reliability prediction matches a target reliability of the first manufacturing vintage of semiconductor devices; and
responsive to determining the second reliability prediction does not match the target reliability of the first manufacturing vintage of semiconductor devices, program instructions to send the second reliability prediction to a user associated with the first manufacturing vintage of semiconductor devices.

17. The computer system of claim 15, wherein program instructions to determine whether the second reliability prediction matches the first reliability prediction further comprises program instructions to determine whether a difference between the second reliability prediction and the first reliability prediction is within a pre-defined threshold value.

18. The computer system of claim 15, further comprising, responsive to determining the second reliability prediction does not match the first reliability prediction, program instructions to update the first reliability model.

19. The computer system of claim 18, wherein updating the first reliability model further comprises including the retrieved manufacturing reliability assessment data and associated failure mechanism identification data in the first reliability model to create a second reliability model.

20. The computer system of claim 15, further comprising, responsive to determining the second reliability prediction does match the first reliability prediction, program instructions to maintain the first reliability model.
